(19) United States
(12) Patent Application Publication
(10) Pub. No.: US 2020/0298868 A1
(43) Pub. Date: Sep. 24, 2020

(54) INFORMATION PROCESSING SYSTEM, SERVER AND PROGRAM

(71) Applicant: TOYOTA JIDOSHA KABUSHIKI KAISHA, Toyota-shi (JP)

(72) Inventors: Daiki KANEICHI, Nisshin-shi (JP); Daisuke TANABE, Nisshin-shi (JP)

(73) Assignee: TOYOTA JIDOSHA KABUSHIKI KAISHA, Toyota-shi (JP)

(21) Appl. No.: 16/813,130

(22) Filed: Mar. 9, 2020

(30) Foreign Application Priority Data
Mar. 19, 2019 (JP) 2019-051161

(51) Int. Cl. B60W 50/00; H04W 4/02; H04W 4/42; G08G 1/0968; B60W 30/06

(52) U.S. Cl. CPC B60W 50/00; H04W 4/025; H04W 4/42; G08G 1/096833; B60W 2050/0077; B60W 2556/50; B60W 2420/42; B60W 2540/041; B60W 30/06

(57) ABSTRACT

An information processing system includes a plurality of vehicles, and a server capable of communicating with the plurality of vehicles. Each of the plurality of the vehicles generates an image resulting from picking up a vehicle exterior view, each of the plurality of the vehicles or the server decides a candidate spot at which a particular vehicle halts in order for a passenger to get on or get off the particular vehicle, based on the image, and the server stores position information about each of a plurality of the candidate spots decided by the plurality of the vehicles.

### INCORPORATION BY REFERENCE

The disclosure of Japanese Patent Application No. 2019-051161 filed on Mar. 19, 2019 including the specification, drawings and abstract is incorporated herein by reference in its entirety.

### BACKGROUND

### 1. Technical Field

The disclosure relates to an information processing system, a server and a program.

### 2. Description of Related Art

Conventionally, technologies relevant to driving assist for vehicles have been known. For example, Japanese Patent Application Publication No. 2003-302236 discloses a navigation device that displays map data to a parking-allowed zone around a destination, based on position data corresponding to the parking-allowed zone.

### SUMMARY

In recent years, for example, there has been a technology relevant to a service in which a plurality of users rides together on a vehicle as passengers, as exemplified by a ride sharing in which a plurality of users rides together on a vehicle and an on-demand bus that can travel along a route other than a prescribed circuit route depending on a ride reservation from a user. In such a service, a traveling route and halt spots are decided each time depending on the ride reservation from the user, unlike conventional fixed-route bus services in which circuit routes and halt spots are previously decided, for example. However, for example, even in the case of a spot at which the vehicle stop is not legally prohibited, the spot is not always appropriate as a halt spot at which a passenger gets on or gets off the vehicle. Accordingly, there is room for improvement in the conventional technology relevant to the service in which a plurality of users rides together on a vehicle as passengers.

An object of the disclosure, which has been made in view of such a circumstance, is to improve the technology relevant to the service in which a plurality of users rides together on a vehicle as passengers.

An information processing system according to an embodiment is

an information processing system including a plurality of vehicles, and a server capable of communicating with the plurality of vehicles, in which:

each of the plurality of the vehicles generates an image resulting from picking up a vehicle exterior view;

each of the plurality of the vehicles or the server decides a candidate spot at which a particular vehicle halts in order for a passenger to get on or get off the particular vehicle, based on the image; and

the server stores position information about each of a plurality of the candidate spots decided by the plurality of the vehicles.

A server according to an embodiment is

a server including a communication unit, a storage unit and a control unit, the communication unit being capable of communicating with a plurality of vehicles each of which generates an image resulting from picking up a vehicle exterior view, in which

the control unit

decides a plurality of candidate spots at each of which a particular vehicle halts in order for a passenger to get on or get off the particular vehicle, based on a plurality of the images generated by the plurality of the vehicles, and

stores position information about each of the plurality of the candidate spots, in the storage unit.

A program according to an embodiment is

a program causing a server to execute steps, the server including a communication unit, a storage unit and a control unit, the communication unit being capable of communicating with a plurality of vehicles each of which generates an image resulting from picking up a vehicle exterior view, the steps including:

a step of deciding a plurality of candidate spots at each of which a particular vehicle halts in order for a passenger to get on or get off the particular vehicle, based on a plurality of the images generated by the plurality of the vehicles; and

a step of storing position information about each of the plurality of the candidate spots, in the storage unit.

The information processing system, the server and the program according to the embodiments can improve the technology relevant to the service in which a plurality of users rides together on a vehicle as passengers.

### BRIEF DESCRIPTION OF THE DRAWINGS

Features, advantages, and technical and industrial significance of exemplary embodiments will be described below with reference to the accompanying drawings, in which like numerals denote like elements, and wherein:

FIG. 1 is a diagram showing a schematic configuration of an information processing system according to an embodiment;

FIG. 2 is a diagram for describing an outline of a service that is performed using the information processing system;

FIG. 3 is a block diagram showing a schematic configuration of a vehicle;

FIG. 4 is a diagram showing an example of an image that is generated by the vehicle;

FIG. 5 is a block diagram showing a schematic configuration of a server;

FIG. 6 is a diagram showing an example of candidate spot information that is stored in the server;

FIG. 7 is a diagram showing an example of stop record information that is stored in the server;

FIG. 8 is a flowchart showing a first behavior of the vehicle;

FIG. 9 is a flowchart showing a second behavior of the vehicle;

FIG. 10 is a flowchart showing a third behavior of the server; and

FIG. 11 is a flowchart showing a fourth behavior of the server.

### DETAILED DESCRIPTION OF EMBODIMENTS

Hereinafter, an embodiment will be described.

Configuration of Information Processing System

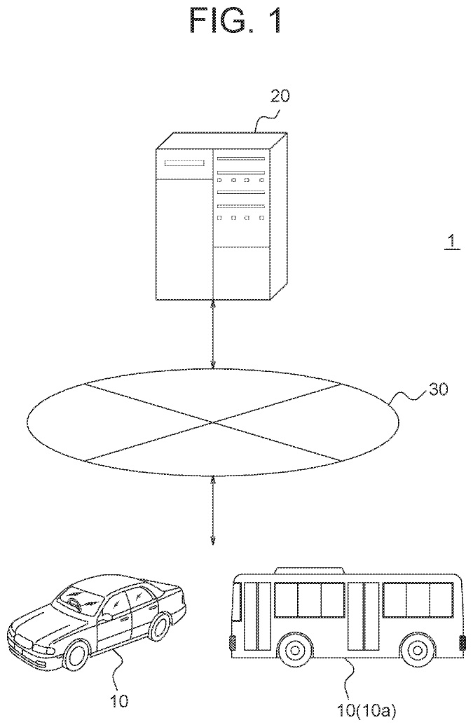

A schematic configuration of an information processing system 1 according to an embodiment will be described with reference to FIG. 1. In the embodiment, the information processing system 1 is used for providing an on-demand bus service in which a vehicle can travel along a route other than a prescribed route depending on a ride reservation from a user. In the on-demand bus service, for example, the vehicle that is used for transportation of a passenger travels along a prescribed circuit route as a general rule, and therewith can exceptionally travel along a route (for example, a route along which the vehicle goes through spots at which the user having performed the ride reservation hopes to get on and get off the vehicle) other than the prescribed route depending on the ride reservation from the user. However, the information processing system 1 is not limited to the on-demand bus service, and may be employed for an arbitrary service in which a plurality of users rides together on a vehicle as passengers.

As shown in FIG. 1, the information processing system 1 includes a plurality of vehicles 10 and a server 20. The vehicles 10 and the server 20 can communicate with each other, for example, through a network 30 including a mobile communication network, the internet and the like.

The plurality of vehicles 10 includes at least one passenger transportation vehicle. The passenger transportation vehicle is, for example, a bus that is used for the on-demand bus service, but without being limited to this bus, may be an arbitrary vehicle on which a plurality of users can ride together as passengers. The plurality of vehicles 10 may further include an arbitrary vehicle different from the passenger transportation vehicle, as exemplified by a passenger car and a cargo transportation vehicle. Hereinafter, when the passenger transportation vehicle is distinguished from other vehicles, the passenger transportation vehicle is also referred to as a “particular vehicle 10a”. In FIG. 1, for simplification of description, only two vehicles 10 are illustrated. However, the information processing system 1 may include two or more vehicles 10, that is, an arbitrary number of vehicles 10. Further, the vehicle 10 may be a vehicle that can perform automatic driving. The automatic driving includes levels 1 to 5 that are defined by Society of Automotive Engineers (SAE), for example, but without being limited to this definition, may be arbitrarily defined. Further, as probe data, the vehicle 10 may send arbitrary information relevant to the vehicle 10, as exemplified by the position or traveling state of the vehicle 10, to the server 20. The sending of the probe data may be performed periodically, for example, but without being limited to the periodical sending, may be performed at an arbitrary timing.

The server 20 includes one server device or a plurality of server devices that can communicate with each other. For example, the server 20 is used by a provider of the on-demand bus service, and manages the ride reservation for the particular vehicle 10a. Specifically, the server 20 associates and stores the user that has performed the ride reservation and the particular vehicle 10a on which the user rides. Further, specifically, the server 20 exchanges arbitrary information relevant to the service, with each of the plurality of vehicles 10. However, other than these processes, the server 20 can execute an arbitrary process relevant to the service. For example, the server 20 may perform a process of accepting the ride reservation from the user. For example, the ride reservation from the user may include information about spots at which the user hopes to get on and get off the particular vehicle 10a. The acceptance of the ride reservation may be performed, for example, by the communication between the server 20 and a terminal device such as a smartphone that is used by the user, or may be performed by an operator that receives a telephone contact from the user.

The server 20 may manage the state of the vehicle 10. Specifically, the server 20 collects and accumulates the probe data that is sent from each of the plurality of vehicles 10, and thereby can recognize the past or current position, traveling state and others of each vehicle 10.

First, an outline of the embodiment will be described, and details will be described later. Each of the plurality of vehicles 10 includes an in-vehicle camera, for example, and generates an image resulting from picking up a vehicle exterior view, during traveling. Based on the image, each of the plurality of vehicles 10 decides a candidate spot at which the particular vehicle 10a halts in order for the passenger to get on or get off the particular vehicle 10a. In the embodiment, for example, the “spot” may mean a point on a map, or may mean a region having a certain area on the map. Details of a technique for deciding the candidate spot based on the image will be described later. The server 20 stores position information about each of a plurality of candidate spots decided by the plurality of vehicles 10.

In this way, with the embodiment, the image picked up while the vehicle 10 actually travels is used for deciding the candidate spot at which the particular vehicle 10a halts in order for the passenger to get on or get off the particular vehicle 10a. Therefore, it is possible to decide, as the candidate spot, a spot that is likely to be appropriate for the passenger to get on or get off the particular vehicle 10a, by detecting a spot at which the passenger can get on or get off the particular vehicle 10a (for example, a spot at which an obstacle such as a guardrail does not exist between a roadway and a sidewalk), from the image, except spots at which the vehicle stop is legally prohibited (for example, a spot near an intersection, a crosswalk or the like, or a spot at which the vehicle stop is prohibited by a sign or a marking; referred to as a “stop prohibition spot”, hereinafter). The storing of the position information about the plurality of candidate spots is useful, for example, for deciding a traveling route of the particular vehicle 10a. Accordingly, a technology relevant to a service in which a plurality of users rides together on a vehicle as passengers is improved.

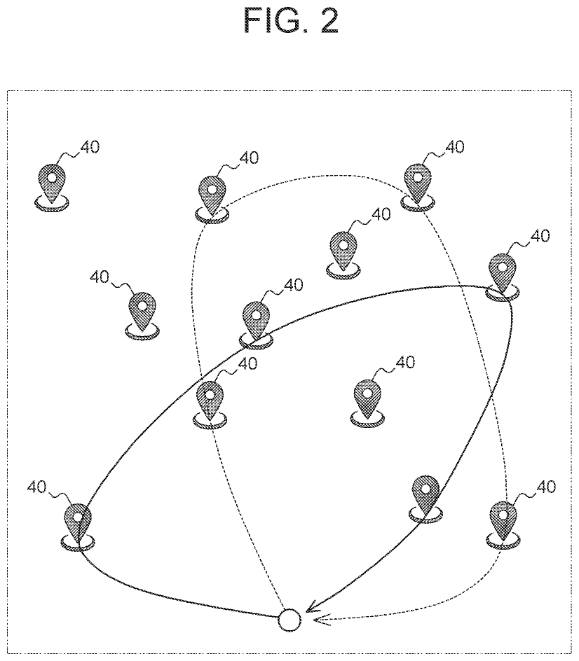

FIG. 2 is a diagram schematically showing a plurality of candidate spots 40 stored in the server 20, on a map. As described above, in the on-demand bus service, a traveling route and halt spots are decided depending on the ride reservation from the user. In the embodiment, depending on the ride reservation from the user, the server 20 may select each of two or more candidate spots 40 from the plurality of candidate spots 40, as the halt spot at which the passenger gets on or gets off the particular vehicle 10a, and may decide the traveling route of the particular vehicle 10a such that the particular vehicle 10a goes through the two or more selected halt spots. For example, a solid arrow and a dashed arrow in FIG. 2 show two traveling routes different in the selected halt spot. This configuration reduces the probability that a spot that is likely to be not appropriate as the halt spot is employed as the halt spot. Accordingly, the technology relevant to the service in which a plurality of users rides together on a vehicle as passengers is further improved.

Next, each configuration of the information processing system 1 will be described in detail.

Configuration of Vehicle

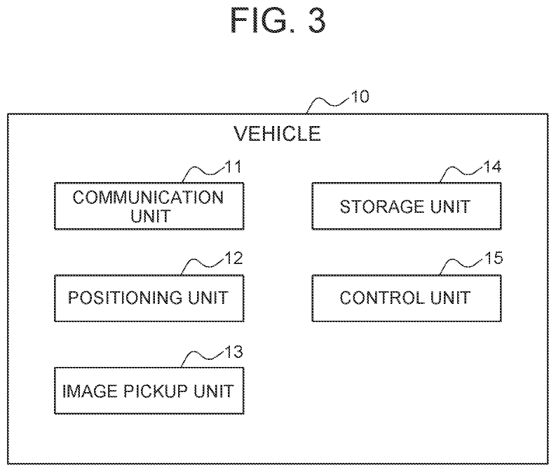

As shown in FIG. 3, the vehicle 10 includes a communication unit 11, a positioning unit 12, an image pickup unit 13, a storage unit 14 and a control unit 15. Each of the communication unit 11, the positioning unit 12, the image pickup unit 13, the storage unit 14 and the control unit 15 may be built in the vehicle 10, or may be provided in the vehicle 10 in a detachable manner. The communication unit 11, the positioning unit 12, the storage unit 14 and the control unit 15 are connected so as to be capable of communicating with each other, for example, through an in-vehicle network such as Controller Area Network (CAN), a dedicated line, or a short-range wireless communication such as Bluetooth (R).

The communication unit 11 includes a communication module that is connected to the network 30. The communication module supports, for example, a mobile communication standard such as 4th Generation (4G) and 5th Generation (5G), but without being limited to these standards, may support an arbitrary communication standard. For example, an in-vehicle communication device such as a data communication module (DCM) may function as the communication unit 11. In the embodiment, the vehicle 10 is connected to the network 30 through the communication unit 11.

The positioning unit 12 includes a receiver that supports a satellite positioning system. The receiver supports, for example, a global positioning system (GPS), but without being limited to the system, may support an arbitrary satellite positioning system. For example, the positioning unit 12 includes a gyroscope sensor and a magnetic field sensor. For example, a car navigation device may function as the positioning unit 12. In the embodiment, the vehicle 10 can acquire the position of the vehicle 10 and the orientation of the vehicle 10, using the positioning unit 12.

The image pickup unit 13 includes an in-vehicle camera that generates an image resulting from picking up a view (that is, a subject) in a visual field. In the embodiment, the “image” may be a still image, or may be a moving image. The in-vehicle camera included in the image pickup unit 13 may be a monocular camera, or may be a stereo camera. The image pickup unit 13 is provided in the vehicle 10, such that the image pickup unit 13 can pick up a vehicle exterior view in at least one direction of a forward direction, a lateral direction and a rearward direction of the vehicle 10. For example, a dashboard camera or an electronic device having a camera function, as exemplified by a smartphone that is used by an occupant, may function as the image pickup unit 13. In the embodiment, the vehicle 10 generates the image resulting from picking up the vehicle exterior view, using the image pickup unit 13.

The storage unit 14 includes one or more memories. In the embodiment, the “memory” is, for example, a semiconductor memory, a magnetic memory or an optical memory, but is not limited to these memories. Each memory included in the storage unit 14 may function, for example, as a main storage device, an auxiliary storage device or a cache memory. In the storage unit 14, arbitrary information that is used for the behavior of the vehicle 10 is stored. For example, a system program, an application program, an embedded software, map information and the like may be stored in the storage unit 14. The map information may previously include information about the stop prohibition spot. The information stored in the storage unit 14 may be updated, for example, based on information that is acquired from the network 30 through the communication unit 11.

The control unit 15 includes one or more processors. In the embodiment, the “processor” is a general-purpose processor, a dedicated processor specialized for a particular process, or the like, but is not limited to these processors. For example, an electronic control unit (ECU) mounted on the vehicle 10 may function as the control unit 15. The control unit 15 has a timer function to obtain the current hour. The control unit 15 controls the whole behavior of the vehicle 10.

For example, the control unit 15 generates the image resulting from picking up the vehicle exterior view, using the image pickup unit 13. For example, the image may be generated during the traveling of the vehicle 10. Based on the image, the control unit 15 decides the candidate spot at which the particular vehicle 10a halts in order for the passenger to get on or get off the particular vehicle 10a. More specifically, the control unit 15 determines whether a spot on the image satisfies a predetermined condition described later, and in the case where the control unit 15 determines that the spot satisfies the predetermined condition, the control unit 15 decides that the spot is a candidate spot.

In the embodiment, the predetermined condition includes a first condition that the spot is a spot at which the vehicle stop is not legally prohibited. For the determination of whether the spot on the image satisfies the first condition, an arbitrary technique can be employed.

For example, in the case where the map information stored in the storage unit 14 includes information about the stop prohibition spot, the control unit 15 may determine whether the position (pickup position) of the vehicle 10 when the image is picked up corresponds to the stop prohibition spot indicated in the map information. Specifically, in the case where the control unit determines that the pickup position does not correspond to the stop prohibition spot, the control unit 15 determines that the spot on the image satisfies the first condition. On the other hand, in the case where the control unit 15 determines that the pickup position corresponds to the stop prohibition spot, the control unit 15 determines that the spot on the image does not satisfy the first condition.

Alternatively, in the case where the map information does not include the information about the stop prohibition spot, the control unit 15 may determine whether the spot on the image corresponds to the stop prohibition spot, based on the image. Specifically, based on the image, the control unit 15 determines whether a predetermined subject, as exemplified by an intersection, a crosswalk, or a traffic sign or road marking indicating the stop prohibition, exists near the spot on the image. For the determination of whether the predetermined subject exists, for example, an arbitrary image recognition algorism such as pattern matching, feature extraction or machine learning can be employed. In the case where the control unit 15 determines that the predetermined subject does not exist, the control unit 15 determines that the spot on the image satisfies the first condition. On the other hand, in the case where the control unit 15 determines that the predetermined subject exists, the control unit 15 determines that the spot on the image does not satisfy the first condition.

Further, the predetermined condition further includes a second condition that the spot is a spot at which the passenger can get on or get off the particular vehicle 10a. In the embodiment, the “spot at which the passenger can get on or get off the particular vehicle 10a” is, for example, a spot at which a sidewalk exists on a roadside and at which an obstacle such as a fence or a guardrail does not exist between the roadway and the sidewalk, but without being limited to this spot, may be an arbitrary spot at which the passenger can get on or get off the particular vehicle 10a without a special difficulty. For the determination of whether the spot on the image satisfies the second condition, an arbitrary technique can be employed.

For example, based on the image, the control unit 15 determines whether the sidewalk exists on the roadside at the spot on the image and whether the obstacle exists between the roadway and the sidewalk at the spot on the image. For the determination of whether the sidewalk exists and the determination of whether the obstacle exists, for example, an arbitrary image recognition algorism such as pattern matching, feature extraction or machine learning can be employed. In the case where the control unit 15 determines that the sidewalk exists and the obstacle does not exist, the control unit 15 determines that the spot on the image satisfies the second condition. On the other hand, in the case where the control unit 15 determines that the sidewalk does not exist or in the case where the control unit 15 determines that the obstacle exists, the control unit 15 determines that the spot on the image does not satisfy the second condition.

For example, based on the image shown in FIG. 4, for a spot A, the control unit 15 determines that the spot A does not correspond to the stop prohibition spot (that is, the first condition is satisfied), and determines that the obstacle does not exist between the roadway and the sidewalk (that is, the second condition is satisfied), so that the control unit 15 can decide that the spot A is a candidate spot. In this way, the control unit 15 decides that a spot that is other than the stop prohibition spot and at which the passenger can get on or get off the particular vehicle is a candidate spot at which the particular vehicle halts in order for the passenger to get on or get off the particular vehicle.

After the control unit 15 decides the candidate spot as described above, the control unit 15 generates candidate spot information, and sends the candidate spot information to the server 20 through the communication unit 11. In the embodiment, the “candidate spot information” includes the position information and priority about the candidate spot.

As the position information about the candidate spot, for example, the pickup position for the image may be used. Alternatively, the control unit 15 may detect the relative position of the candidate spot to the vehicle 10, from the image, and may decide that the position information about the candidate spot is position information resulting from correcting the pickup position with the relative position.

The priority of the candidate spot is a priority for selecting the candidate spot as a halt spot at which the particular vehicle 10a actually halts. As described later, for example, in the case where there is a plurality of candidate spots near a spot at which the user having performed the ride reservation hopes to get on the particular vehicle, a candidate spot having a high priority can be preferentially selected as the halt spot. For example, the priority may be indicated by a numerical value, or may be indicated by a grade (for example, high, middle or low).

The priority of the candidate spot is decided based on an arbitrary environment of the candidate spot that is detected from the image. For example, in the case where the roadway at the candidate spot has two or more lanes each way, a following vehicle can overtake the particular vehicle 10a even if the particular vehicle 10a halts at the candidate spot, and therefore the control unit 15 may give a higher priority than in the case where the roadway has one lane each way. Further, in the case where the form of the roadway at the candidate spot is a straight form, a driver of a following vehicle can visually recognize the halting particular vehicle 10a even from a relatively distant position, and therefore the control unit 15 may give a higher priority than in the case of a curve form. Further, as the width of the sidewalk at the candidate spot is wider, the passenger is likely to get on or get off the particular vehicle 10a more easily, and therefore the control unit 15 may give a higher priority. Further, for example, in the case where the candidate spot is an entrance of a parking lot, the halt of the particular vehicle 10a interferes with another vehicle that enters the parking lot, and therefore the control unit 15 may give a lower priority than in the case where the candidate spot is not an entrance of the parking lot. However, the environment of the candidate spot that is detected from the image is not limited to the number of lanes of the roadway, the form of the roadway, the width of the sidewalk and the entrance of a facility described above, and may be arbitrarily set. Further, for the detection of the environment of the candidate spot, for example, an arbitrary image recognition algorism such as pattern matching, feature extraction or machine learning can be employed.

Further, the control unit 15 determines whether the vehicle 10 has stopped in order for the occupant to get on or get off the vehicle 10. Specifically, the control unit 15 may determine that the vehicle 10 has stopped in order for the occupant to get on or get off the vehicle 10, for example, when the control unit 15 detects that the vehicle speed of the vehicle 10 has become zero and a door has been opened and closed while an ignition is in an on-state or while an accessory is in an on-state, based on information received from the ECU included in the vehicle 10. After the control unit 15 determines that the vehicle 10 has stopped in order for the occupant to get on or get off the vehicle 10, the control unit 15 generates stop record information, and sends the stop record information to the server 20 through the communication unit 11. In the embodiment, the “stop record information” includes information about a stop position and a stop date and hour.

Configuration of Server

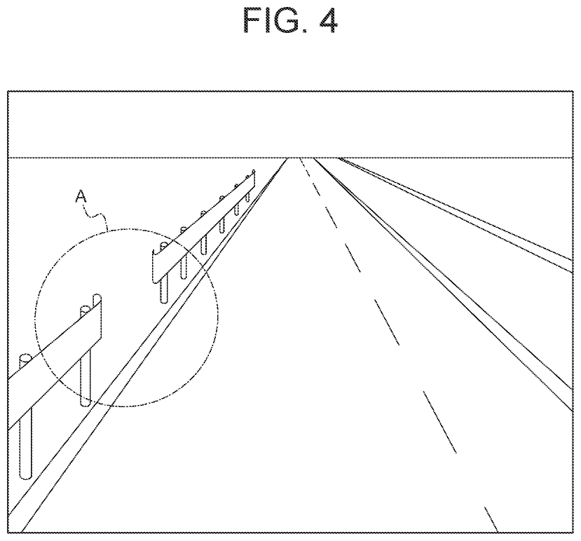

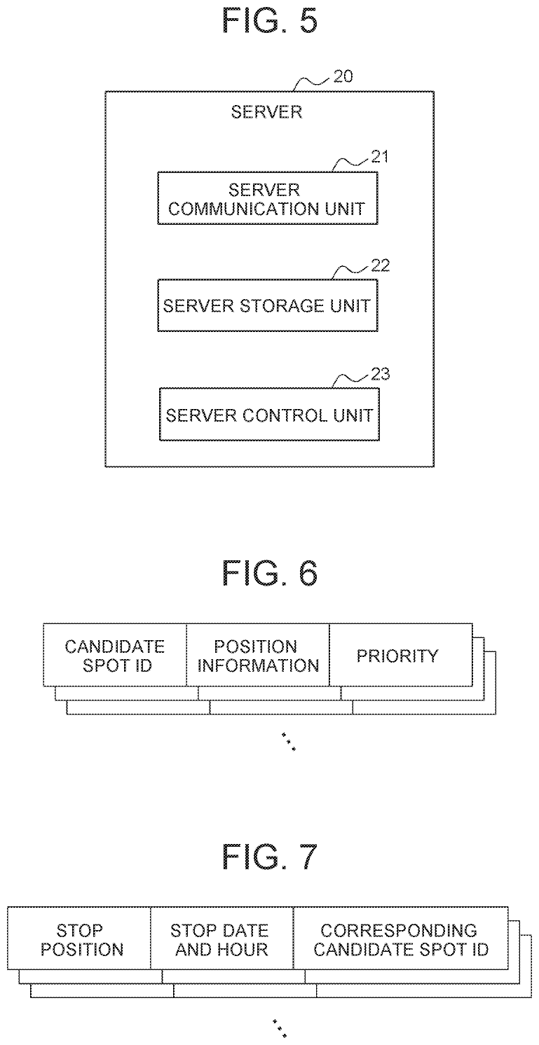

As shown in FIG. 5, the server 20 includes a server communication unit 21, a server storage unit 22 and a server control unit 23.

The server communication unit 21 includes a communication module that is connected to the network 30. The communication module supports, for example, a wired local area network (LAN) standard, but without being limited to this standard, may support an arbitrary communication standard. In the embodiment, the server 20 is connected to the network 30 through the server communication unit 21.

The server storage unit 22 includes one or more memories. Each memory included in the server storage unit 22 may function, for example, as a main storage device, an auxiliary storage device or a cache memory. In the server storage unit 22, arbitrary information that is used for the behavior of the server 20 is stored. For example, a system program, an application program, map information, a vehicle database, a reservation database and the like may be stored in the server storage unit 22. The information stored in the server storage unit 22 may be updated, for example, based on information that is acquired from the network 30 through the server communication unit 21.

In the vehicle database, the probe data sent from each of the plurality of vehicles 10 periodically, for example, is stored and accumulated. The probe data includes, for example, information about the position and traveling state of the vehicle 10, but without being limited to the information, may include arbitrary information relevant to the vehicle 10. By referring to the vehicle database, the server 20 can recognize the past or current position, traveling state and others of each vehicle 10.

In the reservation database, for example, data associated with a user ID of the user having performed the ride reservation and a vehicle ID of the particular vehicle 10a on which the user is scheduled to ride based on the ride reservation is stored. Further, in the reservation database, data about the traveling route of the particular vehicle 10a that is decided by the server control unit 23 described later is stored. However, without being limited to the information, arbitrary information relevant to the ride reservation for the on-demand bus service is stored in the reservation database. Information stored in the reservation database can dynamically change whenever the ride reservation is performed by the user.

The server control unit 23 includes one or more processors. The server control unit 23 controls the whole behavior of the server 20.

For example, the server control unit 23 receives a plurality of pieces of candidate spot information that is sent from the plurality of vehicles 10, through the server communication unit 21, and stores the plurality of pieces of candidate spot information in the server storage unit 22. For example, as shown in FIG. 6, the server control unit 23 may store the position information and priority about the candidate spot that are included in the candidate spot information, in association with a candidate spot ID. Whenever the candidate spot information is sent from the vehicle 10, the candidate spot information is received and stored. In the case where the server control unit 23 receives two or more pieces of candidate spot information having nearly the same position information, the server control unit 23 may store only one piece of the two or more pieces of the candidate spot information, in the server storage unit 22.

Further, the server control unit 23 receives a plurality of pieces of stop record information that is sent from the plurality of vehicles 10, through the server communication unit 21, and stores the plurality of pieces of stop record information in the server storage unit 22. In the case where the plurality of candidate spots in the plurality of candidate spot information includes a candidate spot (that is, a candidate spot corresponding to a stop position) having nearly the same position information as a stop position included in the stop record information, the server control unit 23 may store the stop position and the stop date and hour, in association with the candidate spot ID of the candidate spot corresponding to the stop position, for example, as shown in FIG. 7. For example, the server control unit 23 can calculate a total stop number that is the number of past stops of the vehicles 10, for each candidate spot, based on the plurality of stop record information stored in the server storage unit 22.

The server control unit 23 may update each priority of the plurality of candidate spots stored in the server storage unit 22, based on the plurality of pieces of stop record information. For the update of the priority, an arbitrary technique can be employed. For example, the server control unit 23 calculates the total stop number that is the number of past stops of the vehicles 10 for each candidate spot, based on the plurality of pieces of stop record information stored in the server storage unit 22. The total stop number for each candidate spot may be calculated using the stop record information in an entire period during which the stop record information is stored in the server storage unit 22, or may be calculated using only the stop record information in a recent predetermined period (for example, recent six months). It can be statistically determined that a candidate spot with a large total stop number is a spot advantageous to get on or get off the vehicle 10, for example, a spot at which people can conveniently get on or get off the vehicle 10. The server control unit 23 may perform the update, such that the priority of the candidate spot increases as the total stop number for the candidate spot is larger. Alternatively, the server control unit 23 may perform the update, such that the priority of the candidate spot decreases as the total stop number for the candidate spot is smaller. Further, for example, an average stop number in a predetermined period (for example, one month) may be employed instead of the total stop number.

The server control unit 23 selects each of two or more candidate spots from the plurality of candidate spots, as a halt spot at which the passenger gets on or gets off the particular vehicle 10a, based on the position information about each of the plurality of candidate spots that is stored in the server storage unit 22. For the selection of the halt spot, an arbitrary algorithm can be employed, for example, depending on an operation policy of the on-demand bus service. For example, based on the ride reservation from the user, the server control unit 23 selects a plurality of users near the spot at which the user hopes to get on the particular vehicle 10a in the ride reservation. From the plurality of candidate spots, the server control unit 23 selects candidate spots positioned near spots at which the selected users hope to get on the particular vehicle 10a, as halt spots at which the selected users get on the particular vehicle 10a. Further, the server control unit 23 selects candidate spots positioned near spots at which the selected users hope to get off the particular vehicle 10a, as halt spots at which the users get off the particular vehicle 10a.

The server control unit 23 may select the halt spot based on the position information and priority about each of the plurality of candidate spots. For example, in the case where there are two or more candidate spots near a spot at which the selected user hopes to get on the particular vehicle 10a, the server control unit 23 preferentially selects a candidate spot having a high priority, as the halt spot. In the case where there are two or more candidate spots near a spot at which the selected user hopes to get off the particular vehicle 10a, the server control unit 23 preferentially selects a candidate spot having a high priority, as the halt spot.

In this way, at least two halt spots at which at least one user gets on or gets off the particular vehicle 10a, from the plurality of candidate spots.

The server control unit 23 decides the traveling route of the particular vehicle 10a that goes through the two or more halt spots selected as described above. The server control unit 23 stores the decided traveling route in the reservation database, and gives notice to the particular vehicle 10a through the server communication unit 21. The “traveling route” can include information about a course along which the particular vehicle 10a travels, the position, arrival hour and departure hour for each halt spot, and the number of users that get on or get off the particular vehicle 10a at each halt spot, but is not limited to the information. For example, the given traveling route may be used in order for a driver of the particular vehicle 10a to refer to the traveling route during driving, or may be used for an automatic driving control of the particular vehicle 10a.

The server control unit 23 may select at least one candidate spot from the plurality of candidate spots, as an additional halt spot for the particular vehicle 10a, based on the position information about each of the plurality of candidate spots that is stored in the server storage unit 22, while the particular vehicle 10a is traveling along the traveling route. The selection of the additional halt spot can be performed, for example, in the case where a user newly performs the ride reservation while the particular vehicle 10a is traveling along the traveling route and gets on or gets off the particular vehicle 10a. Specifically, in the case where a spot at which the user hopes to get on or get off the particular vehicle 10a exists near the traveling route, the server control unit 23 may select the additional halt spot in order for the user to get on or get off the particular vehicle 10a. The additional halt spot is a halt spot at which the user gets on or gets off the particular vehicle 10a. In the case where the server control unit 23 selects the additional halt spot, the server control unit 23 alters the traveling route such that the particular vehicle 10a further goes through the additional halt spot, and give notice of the altered traveling route to the particular vehicle 10a.

Behavior Flow of Vehicle

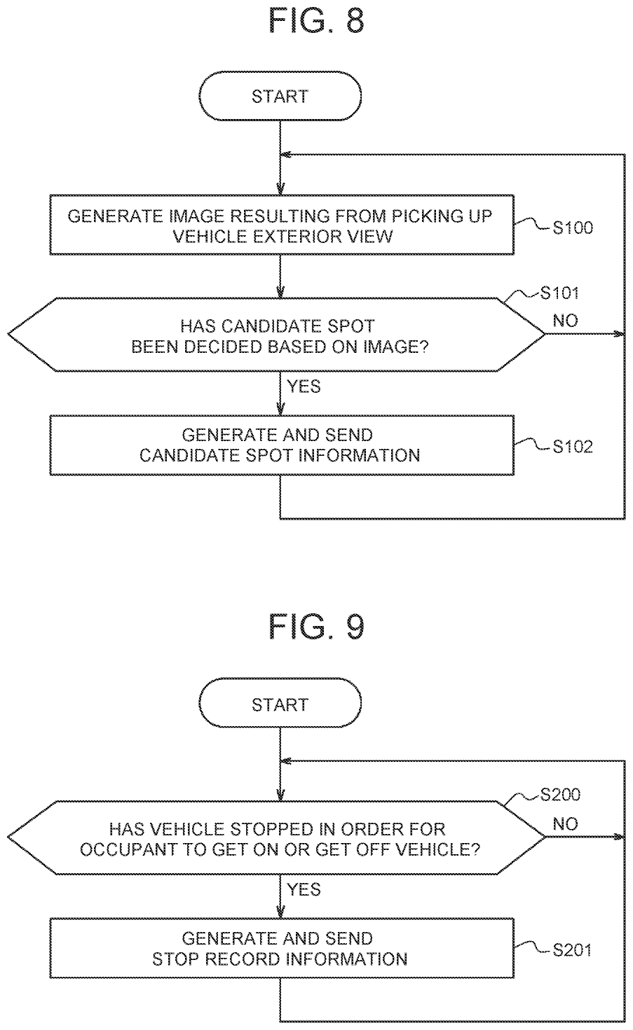

A flow of a first behavior of the vehicle 10 will be described with reference to FIG. 8. As an outline, the first behavior is a behavior of generating the candidate spot information based on the image of the vehicle exterior view.

Step S100: the control unit 15 generates the image resulting from picking up the vehicle exterior view, using the image pickup unit 13.

Step S101: the control unit 15 determines whether the control unit 15 has decided the candidate spot at which the particular vehicle 10a halts in order for the passenger to get on or get off the particular vehicle 10a, based on the image. More specifically, the control unit 15 determines whether a spot on the image satisfies the predetermined condition (for example, the first condition and the second condition), and in the case where the control unit 15 determines that the spot satisfies the predetermined condition, the control unit 15 decides that the spot is a candidate spot. In the case where the control unit 15 determines that the control unit 15 has not decided the candidate spot (step S101—No), the process returns to step S100. On the other hand, in the case where the control unit 15 determines that the control unit 15 has decided the candidate spot (step S101—Yes), the process proceeds to step S102.

Step S102: after the control unit 15 decides the candidate spot in step S101, the control unit 15 generates the candidate spot information including the position information about the candidate spot and the priority for selecting the candidate spot as the halt spot for the particular vehicle 10a, and sends the candidate spot information to the server 20 through the communication unit 11. Thereafter, the process returns to step S100.

A flow of a second behavior of the vehicle 10 will be described with reference to FIG. 9. As an outline, the second behavior is a behavior of generating the stop record information.

Step S200: the control unit 15 determines whether the vehicle 10 has stopped in order for the occupant to get on or get off the vehicle 10. In the case where the control unit 15 determines that the vehicle 10 has not stopped (step S200—No), the process repeats step S200. On the other hand, in the case where the control unit 15 determines that the vehicle 10 has stopped (step S200—Yes), the process proceeds to step S201.

Step S201: after the control unit 15 determines in step S200 that the vehicle 10 has stopped in order for the occupant to get on or get off the vehicle 10, the control unit 15 generates the stop record information including the stop position and the stop date and hour, and sends the stop record information to the server 20 through the communication unit 11. Thereafter, the process returns to step S200.

Behavior Flow of Server

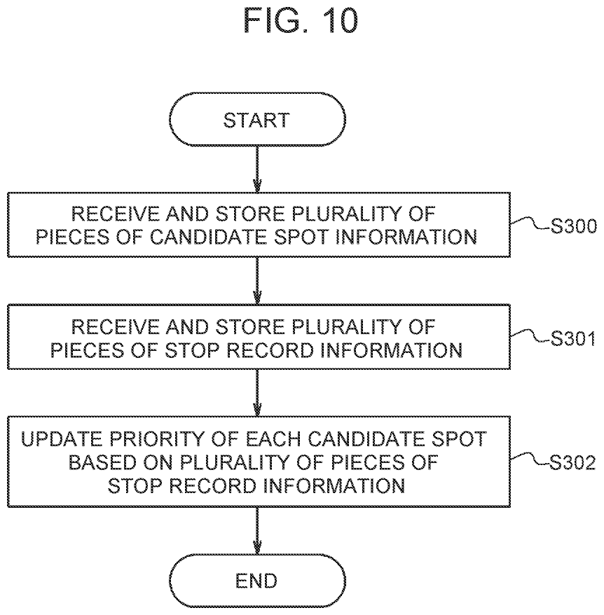

A flow of a third behavior of the server 20 will be described with reference to FIG. 10. As an outline, the third behavior is a behavior of storing and updating the information received from the plurality of vehicles 10.

Step S300: the server control unit 23 receives a plurality of pieces of candidate spot information sent from the plurality of vehicles 10, through the server communication unit 21, and stores the plurality of pieces of candidate spot information in the server storage unit 22.

Step S301: the server control unit 23 receives a plurality of pieces of stop record information sent from the plurality of vehicles 10, through the server communication unit 21, and stores the plurality of pieces of stop record information in the server storage unit 22.

Step S302: the server control unit 23 updates the priority of each of the plurality of candidate spots that is stored in the server storage unit 22, based on the plurality of pieces of stop record information. Then, the process ends.

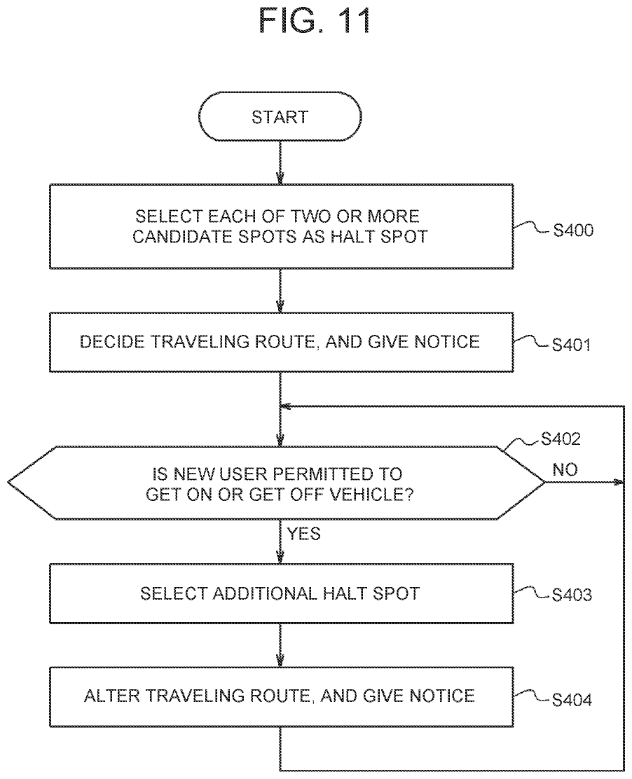

A flow of a fourth behavior of the server 20 will be described with reference to FIG. 11. As an outline, the fourth behavior is a behavior of deciding and altering the traveling route of the particular vehicle 10a.

Step S400: the server control unit 23 selects each of two or more candidate spots from the plurality of candidate spots, as the halt spot at which the passenger gets on or gets off the particular vehicle 10a, based on the position information about each of the plurality of candidate spots that is stored in the server storage unit 22. The server control unit 23 may select the halt spot, based on the position information and priority about each of the plurality of candidate spots.

Step S401: the server control unit 23 decides the traveling route of the particular vehicle 10a that goes through the two or more halt spots selected as described above, and gives notice to the particular vehicle 10a through the server communication unit 21. Here, it is assumed that the particular vehicle 10a starts to travel in accordance with the traveling route, after the notice of the traveling route.

Step S402: the server control unit 23 waits for a ride reservation from a new user, while the particular vehicle 10a is traveling along the traveling route. In the case where the server control unit 23 accepts the ride reservation, the server control unit 23 determines whether the new user is permitted to get on or get off the particular vehicle 10a. For example, in the case where a spot at which the user hopes to get on or get off the particular vehicle 10a exists near the traveling route, the server control unit 23 determines that the user is permitted to get on or get off the particular vehicle 10a, and in the case where the spot does not exist near the traveling route, the server control unit 23 determines that the user is not permitted to get on or get off the particular vehicle 10a. In the case where the server control unit 23 determines that the user is permitted to get on or get off the particular vehicle 10a (step S402—Yes), the process proceeds to step S403. On the other hand, in the case where the server control unit 23 determines that the user is not permitted to get on or get off the particular vehicle 10a (step S402—No), the process repeats step S402, and the server control unit 23 waits for a ride reservation from a new user.

Step S403: the server control unit 23 selects at least one candidate spot from the plurality of candidate spots, as an additional halt spot for the particular vehicle 10a, based on the position information about each of the plurality of candidate spots that is stored in the server storage unit 22. The additional halt spot is a halt spot at which the new user in step S402 gets on or gets off the particular vehicle 10a.

Step S404: the server control unit 23 alters the traveling route such that the particular vehicle 10a further goes through the additional halt spot, and gives notice of the altered traveling route to the particular vehicle 10a. Thereafter, the process returns to step S402.

As described above, in the information processing system 1 according to the embodiment, each of the plurality of vehicles 10 generates the image resulting from picking up the vehicle exterior view, and decides the candidate spot at which the particular vehicle 10a halts in order for the passenger to get on or get off the particular vehicle 10a, based on the image. Then, the server 20 stores the position information about each of the plurality of candidate spots decided by the plurality of vehicles 10. With this configuration, the image picked up while the vehicle 10 actually travels is used for deciding the candidate spot at which the particular vehicle 10a stops in order for the passenger to get on or get off the particular vehicle 10a. Therefore, it is possible to decide, as the candidate spot, a spot that is likely to be appropriate for the passenger to get on or get off the particular vehicle 10a, by detecting a spot at which the passenger can get on or get off the particular vehicle 10a, from the image, except the stop prohibition spot. The storing of the position information about the plurality of candidate spots is useful, for example, for deciding the traveling route of the particular vehicle 10a. Accordingly, the technology relevant to the service in which a plurality of users rides together on a vehicle as passengers is improved.

The disclosure has been described based on the drawings and embodiment. Note that a person skilled in the art easily makes various modifications and alterations based on the disclosure. Accordingly, it should be understood that the modifications and alterations are included in the scope of the disclosure. For example, functions and the like that are included in each constituent or step can be rearranged, such that there is no logical inconsistency, and a plurality of constituents or steps can be combined to one constituent or step, or one constituent or step can be divided.

For example, in the configuration described in the above embodiment, the vehicle 10 decides the candidate spot at which the particular vehicle 10a halts in order for the passenger to get on or get off the particular vehicle 10a, based on the image generated using the image pickup unit 13. The spot decided as the candidate spot is not always appropriate for the particular vehicle 10a to halt, depending on conditions such as the size of the particular vehicle 10a, vehicle type, a door opening-closing mechanism (for example, whether the door is a slide door) or the number of users that ride on the particular vehicle 10a. In this regard, the vehicle 10 may decide the candidate spot based on the image, and may determine a condition (referred to as a “halt condition”, hereinafter) of the particular vehicle 10a that can halt at the candidate spot, based on the image.

For the determination of the halt condition, an arbitrary technique can be employed. For example, the control unit 15 of the vehicle 10 decides the candidate spot based on the image, and then detects the width of a roadway, sidewalk or side strip at the candidate spot, from the image. Depending on the detected width, the control unit 15 determines the vehicle rank, size, vehicle type or door opening-closing mechanism of the particular vehicle 10a that can halt at the candidate spot, as the halt condition. For example, in the case where the width of the roadway, sidewalk or side strip is smaller than a threshold, a condition that the particular vehicle 10a is smaller than a predetermined reference (for example, a condition that the particular vehicle 10a is a microbus) and/or a condition that the number of passengers that ride on the particular vehicle 10a is smaller than a predetermined reference (for example, five) can be determined as the halt condition. The halt condition is designated, for example, using vehicle information such as the size (vehicle rank or dimensions), vehicle type or door opening-closing mechanism (for example, whether the door is a slide door) of the particular vehicle and/or the number of the passengers, but without being limited to the information, may be designated by arbitrary information. When the control unit 15 determines the halt condition, the control unit 15 generates candidate spot information including the position information, priority and halt condition about the candidate spot, and sends the candidate spot information to the server 20 through the communication unit 11. Then, the server control unit 23 of the server 20 stores the received candidate spot information in the server storage unit 22.

With this configuration, the halt condition of the particular vehicle 10a is stored in the server 20 for each candidate spot, and therefore, for example, it is possible to discriminate the candidate spot at which the particular vehicle 10a can halt, from the plurality of candidate spots, at the time of the decision of the traveling route of the particular vehicle 10a. Accordingly, complication of the decision of the traveling route of the particular vehicle 10a based on the plurality of candidate spots is reduced, and therefore the technology relevant to the service in which a plurality of users rides together on a vehicle as passengers is further improved. For the determination of the halt condition, for example, an arbitrary algorism such as machine learning can be employed, without being limited to the above-described algorism using the roadway or the like.

In the above-described embodiment, some of the processing operations that are executed by the vehicle 10 may be executed by the server 20, and some of the processing operations that are executed by the server 20 may be executed by the vehicle 10. Specifically, the process of generating the candidate spot information (that is, the position information and priority about the candidate spot) based on the image generated by the vehicle 10 may be executed by the server 20, instead of the vehicle 10. In this case, the vehicle 10 sends the image resulting from picking up the vehicle exterior view, the pickup position, and the like, to the server 20, and the server 20 generates the candidate spot information, based on the received image and pickup position.

For example, a general-purpose information processing device such as a computer may function as a constituent unit included in the vehicle 10 according the above-described embodiment, or as the server 20. Specifically, a program with a description of processing contents for realizing the functions of the server 20 or the like according to the embodiment is stored in a memory of the information processing device, and the program is read and executed by a processor of the information processing device. Accordingly, the embodiment can be realized also as a program that can be executed by a processor.

What is claimed is:

1. An information processing system comprising a plurality of vehicles, and a server capable of communicating with the plurality of vehicles, wherein:
each of the plurality of the vehicles generates an image resulting from picking up a vehicle exterior view;
each of the plurality of the vehicles or the server decides a candidate spot at which a particular vehicle halts in order for a passenger to get on or get off the particular vehicle, based on the image; and
the server stores position information about each of a plurality of the candidate spots decided by the plurality of the vehicles.

2. The information processing system according to claim 1, wherein:
each of the plurality of the vehicles or the server determines a condition of the particular vehicle capable of halting at the decided candidate spot, based on the image; and
the server stores information indicating the condition, for each of the plurality of the candidate spots.

3. The information processing system according to claim 1, wherein the server selects each of two or more candidate spots from the plurality of the candidate spots, as a halt spot at which the passenger gets on or gets off the particular vehicle, based on the position information about each of the plurality of the candidate spots.

4. The information processing system according to claim 3, wherein:
each of the plurality of the vehicles or the server decides a priority for selecting the decided candidate spot as the halt spot for the particular vehicle, based on the image; and
the server selects the halt spot, based on the position information and the priority about each of the plurality of the candidate spots.

5. The information processing system according to claim 4, wherein:
when each of the plurality of the vehicles stops in order for an occupant to get on or get off the vehicle, the vehicle sends stop record information including a stop position and a stop date and hour, to the server; and
the server
stores a plurality of pieces of the stop record information received from the plurality of the vehicles, and
updates the priority of each of the plurality of the candidate spots, based on the plurality of pieces of the stop record information.

6. The information processing system according to claim 2, wherein the server
decides a traveling route along which the particular vehicle goes through two or more selected halt spots,
gives notice of the traveling route to the particular vehicle,
selects at least one candidate spot from the plurality of the candidate spots, as an additional halt spot for the particular vehicle, based on the position information about each of the plurality of the candidate spots, while the particular vehicle is traveling along the traveling route,
alters the traveling route such that the particular vehicle further goes through the additional halt spot, and
gives notice of the altered traveling route to the particular vehicle.

7. A server comprising a communication unit, a storage unit and a control unit, the communication unit being capable of communicating with a plurality of vehicles each of which generates an image resulting from picking up a vehicle exterior view, wherein
the control unit
decides a plurality of candidate spots at each of which a particular vehicle halts in order for a passenger to get on or get off the particular vehicle, based on a plurality of the images generated by the plurality of the vehicles, and
stores position information about each of the plurality of the candidate spots, in the storage unit.

8. A program causing a server to execute steps, the server comprising a communication unit, a storage unit and a control unit, the communication unit being capable of communicating with a plurality of vehicles each of which generates an image resulting from picking up a vehicle exterior view, the steps comprising:
a step of deciding a plurality of candidate spots at each of which a particular vehicle halts in order for a passenger to get on or get off the particular vehicle, based on a plurality of the images generated by the plurality of the vehicles; and
a step of storing position information about each of the plurality of the candidate spots, in the storage unit.
